(19) United States
(12) Patent Application Publication
(10) Pub. No.: US 2023/0042299 A1
(43) Pub. Date: Feb. 9, 2023

(54) METHOD FOR CHANNEL RESOURCE TRANSMISSION AND DEVICES

(71) Applicant: BEIJING UNISOC COMMUNICATIONS TECHNOLOGY CO., LTD., Beijing (CN)

(72) Inventor: Huan ZHOU, Beijing (CN)

(21) Appl. No.: 17/971,705

(22) Filed: Oct. 24, 2022

Related U.S. Application Data
(63) Continuation of application No. PCT/CN2021/087247, filed on Apr. 14, 2021.

(30) Foreign Application Priority Data
Apr. 22, 2020 (CN) 202010323799.3

(51) Int. Cl. H04W 72/04

(52) U.S. Cl. CPC H04W 72/0413; H04W 72/0446

(57) ABSTRACT

A method for channel resource transmission and devices are provided. The method includes: determining, by a terminal device, a number of first resource elements (REs) for a first uplink control information (UCI) and a number of second REs for a second UCI respectively, the first UCI being carried on a first physical uplink shared channel (PUSCH), the second UCI being carried on a second physical uplink control channel (PUCCH), wherein the first PUSCH overlaps with the second PUCCH in time domain, and the first UCI has a higher priority than the second UCI; mapping, by the terminal device, the second UCI into REs of the first PUSCH with the number of the second REs, and transmitting, by the terminal device, the first PUSCH carrying the first UCI and the second UCI to an access-network device.

### CROSS-REFERENCE TO RELATED APPLICATION(S)

This application is a continuation of International Application No. PCT/CN2021/087247, field Apr. 14, 2021, which claims priority to Chinese Patent Application No. 202010323799.3, filed Apr. 22, 2020, the entire disclosures of which are hereby incorporated by reference.

### TECHNICAL FIELD

This disclosure relates to the field of communication technology, and particularly to a method for channel resource transmission and devices.

### BACKGROUND

5^{th}-generation (5G) new radio (NR) is a global 5G standard for a new air-interface design based on orthogonal frequency division multiplexing (OFDM) technology, and is also the basis for a next-generation cellular mobile communication technology. 5G technology has low latency and high reliability. However, when services of a terminal device have high priority or low priority, if a time-domain resource for data or control information of a low-priority service overlaps with a time-domain resource for data or control information of a high-priority service, the data or control information of the low-priority service is likely to be discarded, which will result in reduced throughput and performance of a communication system.

### SUMMARY

In a first aspect, a method for channel resource transmission is provided in the disclosure. The method includes the following. A terminal device determines the number of first resource elements (RE) for a first UCI and the number of second REs for a second UCI. The first UCI is carried on a first PUSCH, and the second UCI is carried on a second PUCCH. The first PUSCH overlaps with the second PUCCH in time domain, and the first UCI has a higher priority than the second UCI. The terminal device maps the second UCI into REs of the first PUSCH with the number of the second REs. The terminal device transmits the first PUSCH carrying the first UCI and the second UCI to an access-network device.

In a second aspect, a non-transitory computer readable storage medium is provided in the disclosure. The non-transitory computer readable storage medium stores computer-readable programs, which are configured to cause a computer to: determine a number of first resource elements (REs) for a first uplink control information (UCI) and a number of second REs for a second UCI respectively, the first UCI being carried on a first physical uplink shared channel (PUSCH), the second UCI being carried on a second physical uplink control channel (PUCCH), wherein the first PUSCH overlaps with the second PUCCH in time domain, and the first UCI has a higher priority than the second UCI; map the second UCI into REs of the first PUSCH with the number of the second REs; and transmit the first PUSCH carrying the first UCI and the second UCI to an access-network device.

In a third aspect, a terminal device is provided in the disclosure. The terminal device includes a transceiver, a memory and a processor. The memory is configured to store computer-readable instructions. The processor is configured to execute the computer-readable instructions to: determine a number of first resource elements (REs) for a first uplink control information (UCI) and a number of second REs for a second UCI respectively, the first UCI being carried on a first physical uplink shared channel (PUSCH), the second UCI being carried on a second physical uplink control channel (PUCCH), wherein the first PUSCH overlaps with the second PUCCH in time domain, and the first UCI has a higher priority than the second UCI; map the second UCI into REs of the first PUSCH with the number of the second REs; and cause the transceiver to transmit the first PUSCH carrying the first UCI and the second UCI to an access-network device.

### BRIEF DESCRIPTION OF THE DRAWINGS

In order to describe technical solutions of implementations of the disclosure more clearly, the following will give a brief introduction to the accompanying drawings used for describing implementations. Apparently, the accompanying drawings described below are some implementations of the disclosure. Based on these drawings, those of ordinary skill in the art can also obtain other drawings without creative effort.

FIG. 1 is a schematic architectural diagram of a communication system provided in implementations of the disclosure.

FIG. 2 is a schematic flowchart of a method for channel resource transmission provided in implementations of the disclosure.

FIG. 3 is a schematic diagram illustrating resource mapping provided in implementations of the disclosure.

FIG. 4 is a schematic diagram illustrating resource mapping provided in implementations of the disclosure.

FIG. 5 is a schematic diagram illustrating resource mapping provided in implementations of the disclosure.

FIG. 6 is a schematic flowchart of a method for channel resource transmission provided in implementations of the disclosure.

FIG. 7 is a schematic diagram illustrating resource mapping provided in implementations of the disclosure.

FIG. 8 is a schematic diagram illustrating resource mapping provided in implementations of the disclosure.

FIG. 9 is a schematic structural diagram of an apparatus for channel resource transmission provided in implementations of the disclosure.

FIG. 10 is a schematic structural diagram of an apparatus for channel resource transmission provided in implementations of the disclosure.

FIG. 11 is a schematic structural diagram of a terminal device provided in implementations of the disclosure.

FIG. 12 is a schematic structural diagram of an access network device provided in implementations of the disclosure.

### DETAILED DESCRIPTION

Technical solutions of implementations of the disclosure will be described clearly and completely below with reference to the accompanying drawings of the implementations of the disclosure. Apparently, implementations described herein are merely some implementations, rather than all implementations, of the disclosure. Based on the implementations of the disclosure, all other implementations obtained by those of ordinary skill in the art without creative effort shall fall within the protection scope of the disclosure. In addition, the following implementations and features in the implementations may be combined with each other without conflict.

The terms used in the disclosure are merely intended for describing particular implementations, rather than limiting the disclosure. The singular forms “a/an” and “the” used in the disclosure and the claims are also intended to include the plural forms, unless stated otherwise in the context. It should be understood that, the term “and/or” used herein is meant to include any or all possible combinations of one or more listed items associated.

In order for better understanding of implementations of the disclosure, the following will firstly describe a system architecture of implementations of the disclosure.

A method provided in implementations of the disclosure can be applied to various communication systems, which may be, for example, a 5^{th}-generation (5G) communication system, a mixed architecture of long-term evolution (LTE) and 5G, or a 5G new radio (NR) system, or new communication systems that will emerge in future development of communication, etc.

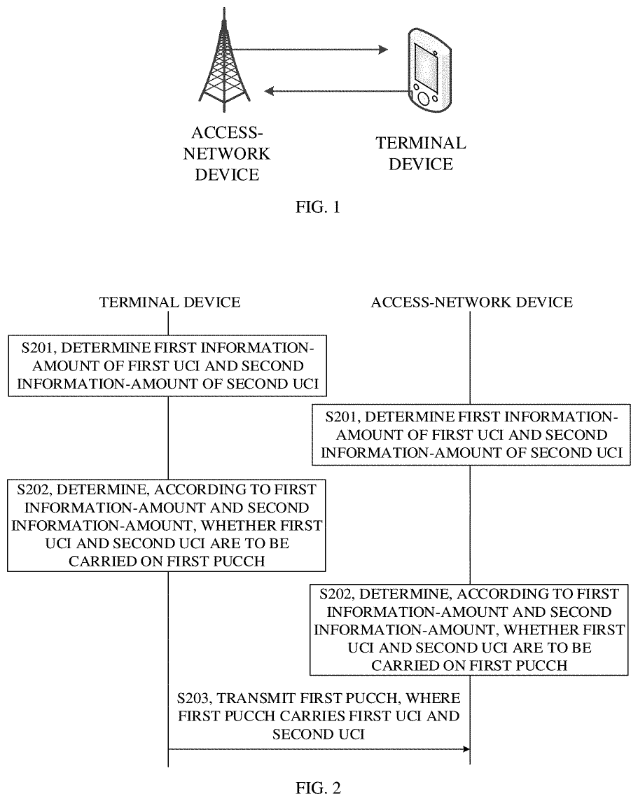

FIG. 1 is a schematic architectural diagram of a communication system provided in implementations of the disclosure. The schemes of the disclosure can be applied to the communication system. The communication system may include at least one access-network device and at least one terminal device. In FIG. 1, the communication system including one access-network device and one terminal device is taken as an example.

In the disclosure, the terminal device is an entity at a user side for receiving or transmitting signals. The terminal device may be a device that provides voice and/or data connectivity to a user. The terminal device may refer to various forms of user equipments (UE), access terminals, subscriber units, subscriber stations, mobile stations (MS), remote stations, remote terminals, mobile devices, user terminals, wireless communication devices, user agents, or user device, etc. The terminal device may also be a cellular phone, a cordless phone, a session initiation protocol (SIP) phone, a wireless local loop (WLL) station, a personal digital assistant (PDA), a handheld device with wireless communication functions, a computing device, or other processing devices connected to a wireless modem, an in-vehicle device, a wearable device, a terminal device in a 5G network, or a terminal device in a future evolved public land mobile network (PLMN), etc. Implementations of the disclosure are not limited in this regard.

The access-network device is a device that provides functions of a base station in 5G NR, which includes gNB. Implementations of the disclosure are not limited in this regard.

Once a connection between the terminal device and the access-network device is established successfully, if there is a high-priority service, the terminal device can transmit first control information on a first physical uplink control channel (PUCCH). If there is a low-priority service, the terminal device can transmit second control information on a second PUCCH. If there are both the high-priority service and the low-priority service, the first PUCCH will overlap the second PUCCH in time domain. To this end, implementations of the disclosure provide a scheme for channel resource transmission, which is possible to realize multiplexing of first uplink control information (UCI) and second UCI, thereby improving throughput and performance of a communication system. Refer to FIG. 2, which is a schematic flowchart of a method for channel resource transmission provided in implementations of the disclosure. As illustrated in FIG. 2, the method can include but is not limited to the following operations.

S201, a terminal device determines a first information-amount of first UCI and a second information-amount of second UCI. Accordingly, an access-network device can also determine the first information-amount of the first UCI and the second information-amount of the second UCI. The first UCI is carried on a first PUCCH, and the second UCI is carried on a second PUCCH. The first PUCCH overlaps with the second PUCCH in time domain, and the first UCI has a higher priority than the second UCI.

S202, the terminal device determines, according to the first information-amount and the second information-amount, whether the first UCI and the second UCI are to be carried on the first PUCCH. Accordingly, the access-network device determines, according to the first information-amount and the second information-amount, whether the first PUCCH carries the first UCI and the second UCI.

The first UCI includes, but is not limited to, a first hybrid automatic repeat request (HARD)-acknowledgement (ACK), first channel state information (CSI), and a first scheduling request (SR). The second UCI includes, but is not limited to, a second HARQ-ACK, second CSI, and a second SR.

Optionally, in implementations of the disclosure, when a connection between the terminal device and the access-network device is established successfully, the access-network device can transmit first configuration information to the terminal device via higher-layer signaling. The first configuration information indicates that the terminal device determines, according to the first information-amount and the second information-amount, whether the first UCI and the second UCI are to be carried on the first PUCCH. Therefore, if the terminal device has detected that the first PUCCH overlaps with the second PUCCH in time domain, the terminal device can determine, according to the first information-amount of the first UCI and the second information-amount of the second UCI, whether the first UCI and the second UCI are to be carried on the first PUCCH.

Since the first PUCCH has different formats, the manner in which the terminal device determines whether the first UCI and the second UCI are to be carried on the first PUCCH differs accordingly, which may include but is not limited to the following manners.

In a possible implementation, if the first PUCCH is of format 0 (PUCCH format 0) or format 1 (PUCCH format 1), and a sum of the first information-amount and the second information-amount is less than or equal to a first channel-capacity threshold corresponding to the first PUCCH, the terminal device determines that the first UCI and the second UCI are to be carried on the first PUCCH. Accordingly, the access-network device determines that the first PUCCH carries the first UCI and the second UCI. The first information-amount is the number of bits in a HARQ-ACK in the first UCI, and the second information-amount is the number of bit in a HARQ-ACK in the second UCI. The first channel-capacity threshold may be 2 bits.

For example, if the first UCI includes 1-bit HARQ-ACK and the second UCI includes 1-bit HARQ-ACK, the first information-amount is 1 bit and the second information-amount is 1 bit, and the sum of the first information-amount and the second information-amount is 2 bits, which is equal to the first channel-capacity threshold. The terminal device determines that the first UCI and the second UCI can be carried on the first PUCCH. Accordingly, the access-network device determines that the first PUCCH carries the first UCI and the second UCI. For another example, if the first UCI includes 2-bit HARQ-ACK and the second UCI includes 1-bit HARQ-ACK, the first information-amount is 2 bits and the second information-amount is 1 bit, and the sum of the first information-amount and the second information-amount is 3 bits, which is greater than the first channel-capacity threshold. In this case, the terminal device determines that the first UCI and the second UCI cannot be carried on the first PUCCH. The terminal device may firstly transmit the first UCI on the first PUCCH and discard the second UCI temporarily, and can transmit the second UCI when initiating a request for low-priority service next time.

In a possible implementation, if the first PUCCH is of format 2 (PUCCH format 2), format 3 (PUCCH format 3), or format 4 (PUCCH format 4), and a third information-amount is less than or equal to a second channel-capacity threshold corresponding to the first PUCCH, the terminal device determines that the first UCI and the second UCI are to be carried on the first PUCCH. Accordingly, the access-network device determines that the first PUCCH carries the first UCI and the second UCI.

The third information-amount is determined according to the first information-amount, the second information-amount, a first code rate (maxCodeRate1) of the first UCI, and a second code rate (maxCodeRate2) of the second UCI. The first information-amount includes information amounts of the first HARQ-ACK, the first CSI, the first SR, and a first cyclic redundancy check (CRC) in the first UCI. The second information-amount includes information amounts of the second HARQ-ACK, the second CSI, the second SR, and a second CRC in the second UCI. The third information-amount is a sum obtained by adding the first information-amount and the second information-amount in proportion, where the proportion is a ratio of the first code rate of the first UCI to the second code rate of the second UCI. The first code rate and the second code rate are pre-configured for the first physical control channel via higher-layer signaling by the access-network device when a connection is established between the access-network device and the terminal device. The first UCI is transmitted on the first PUCCH with the first code rate, and the second UCI is transmitted on the first PUCCH with the second code rate.

Exemplarily, the first information-amount can be calculated according to formula (1) below:

O_{highpriority}=O_{HPACK}+O_{HPSR}+O_{HPCSI}+O_{HPCRC} (1)

O_{HPACK} represents the number of bits in the first HARQ-ACK. If the first UCI does not include HARQ-ACK, O_{HPACK}=0. O_{HPSR} represents the number of bits in the first SR. If the first UCI does not include SR, O_{HPSR}=0. If the first PUCCH is of format 2, O_{HPCSI} represents a reported number of bits in the first CSI; if the first PUCCH is of format 3 or format 4, O_{HPCSI} represents a reported number of bits in high-priority (HP) CSI-1 of the first CSI. O_{HPCRC} represents the number of bits in the first CRC.

The second information-amount can be calculated according to formula (2) below:

O_{lowpriority}=O_{LPACK}+O_{LPSR}+O_{LPCSI}+O_{LPCRC} (2)

O_{LPACK} represents the number of bits in the second HARQ-ACK. If the second UCI does not include HARQ-ACK, O_{LPACK}=0. O_{LPSR} represents the number of bits in the second SR. If the second UCI does not include SR, O_{LPSR}=0. If first PUCCH is of format 2, O_{LPCSI} represents a reported number of bits in the second CSI; if the first PUCCH is of format 3 or format 4, O_{LPCSI} represents a reported number of bits in low-priority (LP) CSI-1 of the second CSI. O_{LPCRC} represents the number of bits in the second CRC.

Whether the first UCI and the second UCI are to be carried on the first PUCCH can be determined according to formula (3) below.

O_{highpriority}+βO_{lowpriority}≤M_{RB}^{PUCCH}·N_{sc,ctrl}^{RB}·N_{symb}^{PUCCH}·Qₘ·r (3)

M_{RB}^{PUCCH} represents the number of resource blocks (RB) contained in the first PUCCH. N_{sc,ctrl}^{RB} represents the number of subcarriers contained in RBs of the first PUCCH. N_{symb}^{PUCCH} represents the number of valid symbols in the first PUCCH when the first PUCCH is of format 2, format 3, or format 4. Qₘ represents a modulation divisor. r represents the first code rate configured for the first physical control channel by the access-network device via higher-layer signaling. β represents a ratio of the first code rate of the first UCI to the second code rate of the second UCI.

S203, the terminal device transmits the first PUCCH to the access-network device. Accordingly, the access-network device receives the first PUCCH from the terminal device. The first PUCCH carries the first UCI and the second UCI.

After determining that the first UCI and the second UCI are to be carried on the first PUCCH, the terminal device transmits the first UCI and the second UCI on the first PUCCH, thereby realizing multiplexing of the first UCI and the second UCI. The manner of multiplexing includes but is not limited to the following.

In a possible implementation, the first PUCCH is of format 0. For example, the first UCI includes 1-bit HARQ-ACK, the second UCI includes 1-bit HARQ-ACK, and the terminal device transmits the 2 bits of HARQ-ACK on the first PUCCH by using four sequences r_{u,v}^{(α}^{_{\tilde{p}}}⁾(n) each having a length of 12. The four sequences may be represented by {x₀(n) x₁(n) x₂(n) x₃(n)}, and the four sequences use the same sequence index and differ by 3 in cyclic shift. r_{u,v}^{(α}^{_{\tilde{p}}}⁾(n) is a cyclic shift on a base sequence. The base sequence is configured via a cell-level radio resource control (RRC) parameter, remaining minimum system information (RMSI), and different base sequences can be used in different slots based on configured identities (ID).

In a possible implementation, the first PUCCH is of format 1. For example, the first UCI includes 1-bit HARQ-ACK, the second UCI includes 1-bit HARQ-ACK, and the 2 bits of HARQ-ACK are transmitted on the first PUCCH. The terminal device firstly generates a symbol by modulating the HARQ-ACK through binary phase shift keying (BPSK) or quadrature phase shift keying (QPSK). The symbol is multiplied by a base sequence with a length of 12 and then multiplied by a time-domain orthogonal cover code (OCC), and finally mapped onto twelve subcarriers of a corresponding time-domain symbol for transmission.

In a possible implementation, the first PUCCH is of format 2, and target resource elements (RE) for the first PUCCH are used for demodulation reference signal (DMRS) transmission. Before the terminal device transmits the first PUCCH to the access-network device, the terminal device obtains first jointly-encoded information by performing joint encoding on the first UCI, and obtains second jointly-encoded information by performing joint encoding on the second UCI. The terminal device maps the first jointly-encoded information, starting from first non-target RE in an order of firstly frequency domain and then time domain. The terminal device maps the second jointly-encoded information, starting from first (1^{st}) non-target RE in remaining REs for the first physical control channel in the order of firstly frequency domain and then time domain. After the first UCI and the second UCI are mapped into REs for the first PUCCH by the terminal device, the terminal device transmits the first PUCCH to the access-network device. The first jointly-encoded information is obtained by performing joint encoding on the first UCI in an order of HP HARQ-ACK, HP SR, and HP CSI. The second jointly-encoded information is obtained by performing joint encoding on the second UCI in an order of LP HARQ-ACK, LP SR, and LP CSI.

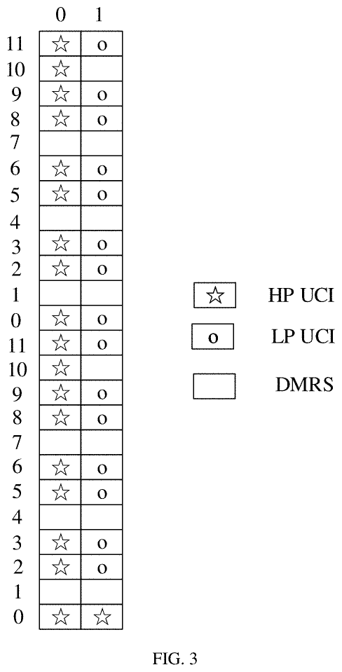

For example, refer to FIG. 3, which is a schematic diagram illustrating resource mapping provided in implementations of the disclosure. FIG. 3 illustrates a resource for the first PUCCH which includes two OFDM symbols in time domain and two physical resource blocks (PRB) in frequency domain. REs with indexes 1, 4, and 7 in frequency domain are target REs used for DMRS transmission. The first non-target RE is an RE with index 0 in a first OFDM symbol from the left. The terminal device maps the first jointly-encoded information, starting from the first non-target RE in the order of firstly frequency domain and then time domain. Mapping of the first UCI is completed when the first UCI is mapped onto an RE corresponding to index 0 in a second OFDM symbol. Then the terminal device maps the second jointly-encoded information, starting from an RE corresponding to index 2 in the second OFDM symbol in the order of firstly frequency domain and then time domain. Then the terminal device transmits the first PUCCH to the access-network device.

In a possible implementation, the first PUCCH is of format 3 or format 4, and target REs for the first PUCCH are used for DMRS transmission. Before the terminal device transmits the first PUCCH to the access-network device, the terminal device obtains first jointly-encoded information and first separately-encoded information by encoding the first UCI, and obtains second jointly-encoded information and second separately-encoded information by encoding the second UCI. The terminal device maps the first jointly-encoded information evenly onto REs which are at both sides of the target REs in an order of firstly frequency domain and then time domain. The terminal device maps the second jointly-encoded information evenly onto REs which are at both sides of the target REs, other than REs corresponding to the first jointly-encoded information, in the order of firstly frequency domain and then time domain. The terminal device maps the first separately-encoded information onto a first remaining resource in the order of firstly frequency domain and then time domain, where the first remaining resource is REs in a resource for the first PUCCH other than the REs corresponding to the first jointly-encoded information and REs corresponding to the second jointly-encoded information. The terminal device maps the second separately-encoded information onto a second remaining resource in the order of firstly frequency domain and then time domain, where the second remaining resource is REs in the resource for the first PUCCH other than the REs corresponding to the first jointly-encoded information, the REs corresponding to the second jointly-encoded information, and REs corresponding to the first separately-encoded information. After the first UCI and the second UCI are mapped onto the resource for the first PUCCH by the terminal device, the terminal device transmits the first PUCCH to the access-network device.

The first jointly-encoded information is obtained by performing joint encoding on the first UCI in an order of HP HARQ-ACK, HP SR, and HP CSI-1. The second jointly-encoded information is obtained by performing joint encoding on the second UCI in an order of LP HARQ-ACK, LP SR, and LP CSI-1. The first separately-encoded information is obtained by performing separate channel encoding on HP CSI-2 of the first CSI. The second separately-encoded information is obtained by performing separate channel encoding on LP CSI-2 of the second CSI.

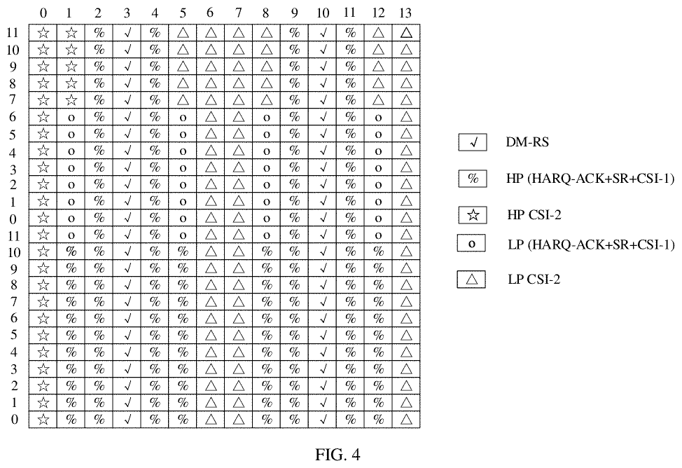

For example, refer to FIG. 4, which is a schematic diagram illustrating resource mapping provided in implementations of the disclosure. FIG. 4 illustrates a resource for the first PUCCH which includes fourteen OFDM symbols in time domain and two PRBs in frequency domain. REs corresponding to OFDM symbols with indexes 3 and 10 are target REs used for DMRS transmission. The terminal device maps the first jointly-encoded information evenly onto both sides of the target REs in the order of firstly frequency domain and then time domain, as denoted by square grids with “%” in FIG. 4. Then the terminal device maps the second jointly-encoded information evenly onto both sides of the target REs except the REs corresponding to the first jointly-encoded information, in the order of firstly frequency domain and then time domain, as denoted by square grids with “o” in FIG. 4. Then the terminal device maps the first separately-encoded information onto the first remaining resource in the order of firstly frequency domain and then time domain, as denoted by square grids with “⋆” in FIG. 4. The terminal device maps the second separately-encoded information onto the second remaining resource in the order of firstly frequency domain and then time domain, as denoted by square grids with “Δ” in FIG. 4.

In a possible implementation, the first PUCCH is of format 3 or format 4, and target REs for the first PUCCH are used for DMRS transmission. Before the terminal device transmits the first PUCCH to the access-network device, the terminal device obtains first jointly-encoded information and first separately-encoded information by encoding the first UCI, and obtains second jointly-encoded information and second separately-encoded information by encoding the second UCI. The terminal device maps the first jointly-encoded information evenly onto REs which are at both sides of the target REs in an order of firstly frequency domain and then time domain. The terminal device maps the first separately-encoded information onto a first remaining resource in the order of firstly frequency domain and then time domain, where the first remaining resource is REs in a resource for the first PUCCH other than REs corresponding to the first jointly-encoded information. The terminal device maps the second jointly-encoded information onto a second remaining resource in the order of firstly frequency domain and then time domain, where the second remaining resource is REs in the resource for the first PUCCH other than the REs corresponding to the first jointly-encoded information and REs corresponding to the first separately-encoded information. The terminal device maps the second separately-encoded information onto a third remaining resource in the order of firstly frequency domain and then time domain, where the third remaining resource is REs in the resource for the first PUCCH other than the REs corresponding to the first jointly-encoded information, REs corresponding to the second jointly-encoded information, and the REs corresponding to the first separately-encoded information. After the first UCI and the second UCI are mapped onto the resource for the first PUCCH by the terminal device, the terminal device transmits the first PUCCH to the access-network device.

The first jointly-encoded information is obtained by performing joint encoding on the first UCI in an order of HP HARQ-ACK, HP SR, and HP CSI-1. The second jointly-encoded information is obtained by performing joint encoding on the second UCI in an order of LP HARQ-ACK, LP SR, and LP CSI-1. The first separately-encoded information is obtained by performing separate channel encoding on HP CSI-2 of the first CSI. The second separately-encoded information is obtained by performing separate channel encoding on LP CSI-2 of the second CSI.

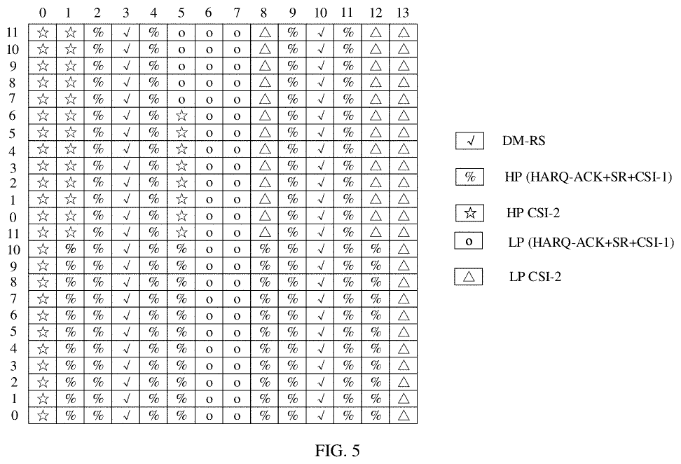

For example, refer to FIG. 5, which is a schematic diagram illustrating resource mapping provided in implementations of the disclosure. FIG. 5 illustrates a resource for the first PUCCH which includes fourteen OFDM symbols in time domain and two PRBs in frequency domain. REs corresponding to OFDM symbols with indexes 3 and 10 are target REs used for DMRS transmission. The terminal device maps the first jointly-encoded information evenly onto both sides of the target REs in the order of firstly frequency domain and then time domain, as denoted by square grids with “%” in FIG. 5. Then the terminal device maps the first separately-encoded information onto the first remaining resource in the order of firstly frequency domain and then time domain, as denoted by square grids with “o” in FIG. 5. Then the terminal device maps the second jointly-encoded information onto the second remaining resource in the order of firstly frequency domain and then time domain, as denoted by square grids with “⋆” in FIG. 4. The terminal device maps the second separately-encoded information onto the third remaining resource in the order of firstly frequency domain and then time domain, as denoted by square grids with “Δ” in FIG. 5.

In implementations of the disclosure, if the first PUCCH carrying the first UCI overlaps with the second PUCCH carrying the second UCI in time domain, the terminal device firstly determines information amounts of the first UCI and the second UCI, and then according to whether the information amounts exceed a channel capacity of the first PUCCH, the terminal devices determines whether the first UCI and the second UCI are to be carried on the first PUCCH. If the information amounts of the first UCI and the second UCI do not exceed the channel capacity of the first PUCCH, the first UCI and the second UCI can be multiplexed, thereby avoiding discarding of the second UCI. Therefore, by implementing the implementations of the disclosure, it is possible to improve throughput and performance of a communication system.

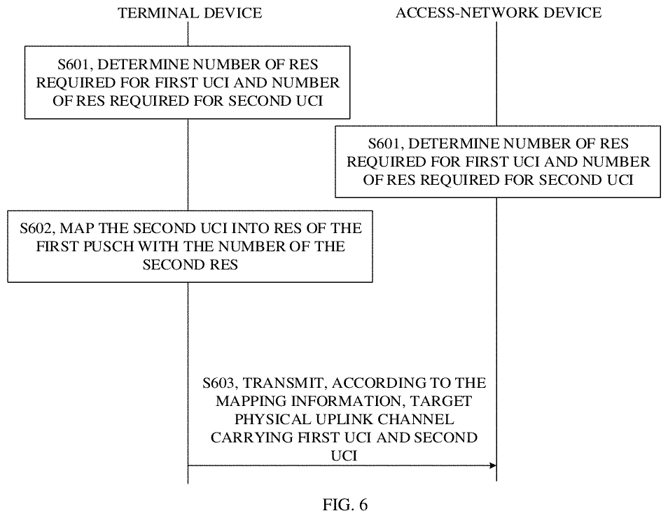

Once a connection between a terminal device and an access-network device is established successfully, if there is a high-priority service, the terminal device can transmit first UCI and data on a first physical uplink shared channel (PUSCH). If there is a low-priority service, the terminal device can transmit second UCI on a second PUCCH. If there are both the high-priority service and the low-priority service, the first PUSCH will overlap with the second PUCCH in time domain. To this end, the disclosure provides a scheme for channel resource transmission, which is possible to realize multiplexing of first UCI and second UCI, thereby improving throughput and performance of a communication system. Refer to FIG. 6, which is a schematic flowchart of a method for channel resource transmission provided in implementations of the disclosure. As illustrated in FIG. 6, the method can include but is not limited to the following operations.

S601, a terminal device determines the number of first REs for a first UCI and the number of second REs for a second UCI respectively. Accordingly, an access-network device determines the number of the first REs for the first UCI and the number of the second REs for the second UCI. The first UCI is carried on a first PUSCH, and the second UCI is carried on a second PUCCH. The first PUSCH overlaps with the second PUCCH in time domain. The first UCI has a higher priority than the second UCI.

The first UCI includes, but is not limited to, a first HARQ-ACK (HP HARQ-ACK), HP CSI-1 and HP CSI-2 of a first CSI, and a first SR (HP SR). The second UCI includes, but is not limited to, a second HARQ-ACK (LP HARQ-ACK), LP CSI-1 and LP CSI-2 of the second CSI, and a second SR (LP SR).

Optionally, when a connection between the terminal device and the access-network device is established successfully, the access-network device can transmit second configuration information to the terminal device via higher-layer signaling. The second configuration information indicates to configure offset-parameter groups for the first UCI and the second UCI of the terminal device. The offset-parameter group is one group including β_{offset}^{HARQ-ACK}, β_{offset}^{CSI-1}, and β_{offset}^{CSI-2}. β_{offset}^{HARQ-ACK} is used for calculating the number of REs occupied by a HARQ-ACK in a resource for a physical channel. β_{offset}^{CSI-1} is used for calculating the number of REs occupied by CSI-1 in a resource for a physical channel. β_{offset}^{CSI-2} is used for calculating the number of REs occupied by CSI-2 in a resource for a physical channel.

In a possible implementation, the offset-parameter groups configured for the terminal device by the access-network device via higher-layer signaling are static, that is, the first UCI corresponds to one offset-parameter group, and the second UCI corresponds to one offset-parameter group. The terminal device can determine the number of the first REs for the first UCI directly according to the offset-parameter group for the first UCI; and the terminal device can determine the number of the second REs for the second UCI according to the offset-parameter group for the second UCI. Accordingly, the access-network device can also determine the number of the first REs for the first UCI and the number of the second REs for the second UCI according to the offset-parameter groups configured for the terminal device. The number of the first REs for the first UCI represents the number of REs for the first HARQ-ACK, the number of REs for CSI-1 of the first CSI, and the number of REs for CSI-2 of the first CSI. The number of the second REs for the second UCI represents the number of REs for the second HARQ-ACK, the number of REs for CSI-1 of the second CSI, and the number of REs for CSI-2 of the second CSI.

In a possible implementation, the offset-parameter groups configured for the terminal device by the access-network device via higher-layer signaling are dynamic. In this case, when determining the number of the first REs for the first UCI and the number of the second REs for second UCI, the terminal device needs to receive indication information from the access-network device. The indication information indicates a first offset-parameter group for the first UCI and a second offset-parameter group for the second UCI. The first offset-parameter group and the second offset-parameter group are selected from offset-parameter groups. The indication information may be carried in downlink control information (DCI) and indicate via a 2-bit field in the DCI.

Manner 1, if the offset-parameter groups include a first set of offset-parameter groups and a second set of offset-parameter groups, and the first set of offset-parameter groups and the second set of offset-parameter groups each include m offset parameter groups, the indication information indicates that the first offset-parameter group is an i^{th} group among the first set of offset-parameter groups and the second offset-parameter group is an i^{th} group among the second set of offset-parameter groups.

For example, if m=4, offset-parameter groups in the first set of offset-parameter groups may be numbered as 1, 2, 3, and 4 respectively, and offset-parameter groups in the second set of offset-parameter groups may be numbered as 1, 2, 3, and 4 respectively. If the indication information is “2”, it indicates that the first offset-parameter group is the 2^{nd} group among the first set of offset-parameter groups, and the second offset-parameter group is the 2^{nd} group among the second set of offset-parameter groups.

Manner 2, if the offset-parameter groups include n sets of offset-parameter groups, and each set of offset-parameter groups includes two offset parameter groups, the indication information indicates that the first offset-parameter group is a first group among a j^{th} set of offset-parameter groups and the second offset-parameter group is a second group among the j^{th} set of offset-parameter groups, where the j^{th} set of offset-parameter groups is selected from the n sets of offset-parameter groups.

For example, n=4. If the indication information is “2”, it indicates that the first offset-parameter group is the 1^{st} group in the 2^{nd} set of offset-parameter groups, and the second offset-parameter group is the 2^{nd} group in the 2^{nd} set of offset-parameter groups.

As such, the terminal device can determine the number of the first REs for the first UCI according to the first offset-parameter group, and determine the number of the second REs for the second UCI according to the second offset-parameter group. Accordingly, the access-network device can also determine the number of the first REs for the first UCI and the number of the second REs for the second UCI according to the offset-parameter groups indicated by the indication information. The number of the first REs for the first UCI represents the number of REs for the first HARQ-ACK, the number of REs for CSI-1 of the first CSI, and the number of REs for CSI-2 of the first CSI. The number of the second REs for the second UCI represents the number of REs for the second HARQ-ACK, the number of REs for CSI-1 of the second CSI, and the number of REs for CSI-2 of the second CSI.

S602, the terminal device maps the second UCI into REs of the first PUSCH with the number of the second REs.

S603, the terminal device transmits the first PUSCH carrying the first UCI and the second UCI to the access-network device. Accordingly, the access-network device receives the first PUSCH carrying first UCI and the second UCI.

The terminal device transmits the first PUSCH carrying the first UCI and the second UCI to the access-network device. Specifically, target REs for the first PUSCH are used for DMRS transmission. The terminal device maps the first UCI, starting from the 1^{st} non-target RE in the first PUSCH in an order of firstly frequency domain and then time domain. The terminal device maps the second UCI, starting from the 1^{st} non-target RE in remaining REs of the first PUSCH in the order of firstly frequency domain and then time domain. The terminal device transmits the first PUSCH carrying the first UCI and the second UCI to the access-network device. The following will elaborate several possible implementations in terms of different target physical uplink channels.

The first PUSCH further carries uplink shared channel (UL-SCH) data. Therefore, the terminal device has to further determine the number of REs that the UL-SCH needs to occupy in the first PUSCH. The terminal device determines the mapping information according to the numbers of REs for the first HARQ-ACK, CSI-1 of the first CSI, and CSI-2 of the first CSI, the numbers of REs for the second HARQ-ACK, CSI-1 of the second CSI, and CSI-2 of the second CSI, and the number of REs for the UL-SCH. The terminal device performs resource mapping on the first UCI in an order of firstly the first HARQ-ACK, then CSI-1 of the first CSI, and finally CSI-2 of the first CSI. After mapping of the first UCI is completed, the terminal device performs resource mapping on the second UCI, without taking into consideration an order among the second HARQ-ACK, CSI-1 of the second CSI, and CSI-2 of the second CSI.

Specifically, the terminal device maps the first HARQ-ACK in the order of firstly frequency domain and then time domain, starting from the 1^{st} symbol which is after an OFDM symbol corresponding to the target REs.

The terminal device maps CSI-1 of the first CSI, starting from an OFDM symbol corresponding to the 1^{st} non-target RE in the first PUSCH. CSI-1 of the first CSI cannot be mapped onto an RE(s) reserved for the first HARQ-ACK, or REs onto which the first HARQ-ACK is mapped. CSI-1 of the first CSI is not frequency-division multiplexed with a coherently demodulated signal.

The terminal device maps CSI-2 of the first CSI, starting from the OFDM symbol corresponding to the 1^{st} non-target RE in the first PUSCH. CSI-2 of the first CSI can be mapped onto the RE(s) reserved for the first HARQ-ACK, but cannot be mapped onto the REs onto which the first HARQ-ACK is mapped or REs onto which CSI-1 is mapped. CSI-2 of the first CSI is not frequency-division multiplexed with a coherently demodulated signal.

The terminal device maps the second UCI, starting from the OFDM symbol corresponding to the 1^{st} non-target RE in REs of the first PUSCH. The second UCI can be mapped onto the RE(s) reserved for the first HARQ-ACK, but cannot be mapped onto a RE(s) onto which the first UCI is mapped. The second UCI is not frequency-division multiplexed with a coherently demodulated signal.

The terminal device maps the UL-SCH, starting from an OFDM symbol corresponding to the 1^{st} non-target RE in remaining REs of the first PUSCH.

When mapping the first HARQ-ACK, CSI-1 of the first CSI, and CSI-2 of the first CSI, the terminal device adopts distributed mapping with an interval d. In other words, positions of REs occupied by the first UCI in each OFDM symbol are as follows.

If the number of REs for unmapped first UCI after scheduling is greater than the number of available REs in an OFDM symbol, d=1. That is, if there is still unmapped first UCI, the terminal device will continue to map the first UCI onto a next OFDM symbol.

If the number of REs for the unmapped first UCI after scheduling is less than the number of available REs in an OFDM symbol, d is equal to a ratio of the number of available REs in an OFDM symbol to the number of REs after scheduling.

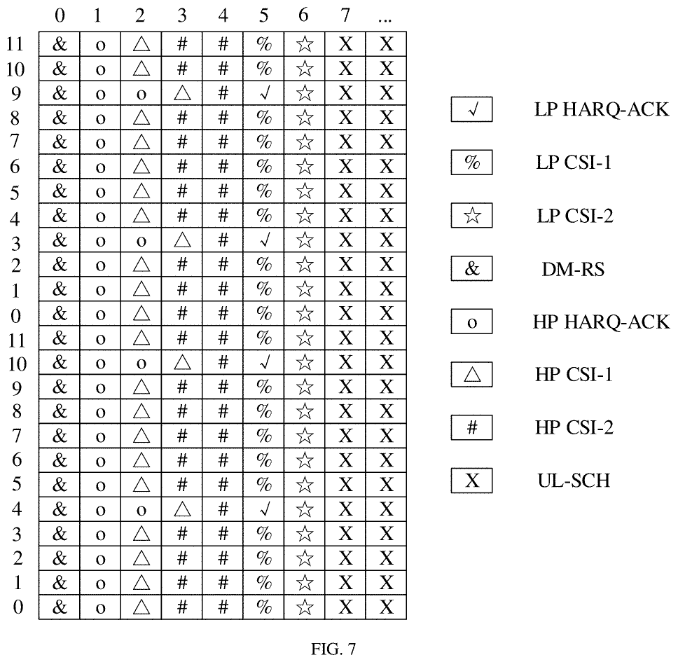

For example, refer to FIG. 7, which is a schematic diagram illustrating resource mapping provided in implementations of the disclosure. As illustrated in FIG. 7, an OFDM symbol with index 0 is used for transmission of a coherently demodulated signal which can also be referred to as a front loaded DMRS, as denoted by square grids with “&” in FIG. 7. The terminal device maps the first HARQ-ACK, starting from an OFDM symbol with index 1. Since the number of REs for the first HARQ-ACK is greater than the number of available REs in the OFDM symbol with index 1, d=1. The terminal device maps unmapped first HARQ-ACK onto an OFDM symbol with index 2. The number of REs for the first HARQ-ACK is less than the number of available REs in the OFDM symbol with index 2, and thus the terminal device maps the unmapped first HARQ-ACK onto REs corresponding to indexes 4, 10, 3, and 9 in frequency domain in the OFDM symbol with index 2, as denoted by square grid with “o” in FIG. 7. Then the terminal device maps CSI-1 of the first CSI, starting from an RE with index 0 in frequency domain in the OFDM symbol with index 2, and CSI-1 of the first CSI cannot be mapped onto the REs corresponding to indexes 4, 10, 3, and 9 in frequency domain onto which the first HARQ-ACK is mapped, as denoted by square grids with “Δ” in FIG. 7. Then the terminal device maps CSI-2 of the first CSI, starting from an RE with index 0 in frequency domain in an OFDM symbol with index 3, and CSI-2 of the first CSI cannot be mapped onto REs with indexes 4, 10, 3, and 9 in frequency domain onto which CSI-1 is mapped, as denoted by square grids with “#” in FIG. 7. Then the terminal device maps the second UCI, starting from an RE with index 0 in frequency domain in an OFDM symbol with index 5, as denoted by square grids with “√”, “⋆”, and “%” in FIG. 7. Finally, the terminal device maps the UL-SCH, starting from an RE with index 0 in frequency domain in an OFDM symbol with index 7, as denoted by square grids with “X” in FIG. 7.

Alternatively, different from the above technical scheme, in a possible implementation, the first UCI and the second UCI are to be carried on the second PUCCH. The terminal device determines mapping information according to the numbers of REs for the first HARQ-ACK, CSI-1 of the first CSI, and CSI-2 of the first CSI, and the numbers of REs for the second HARQ-ACK, CSI-1 of the second CSI, and CSI-2 of the second CSI. The terminal device performs resource mapping on the first UCI in an order of firstly the first HARQ-ACK, then CSI-1 of the first CSI, and finally CSI-2 of the first CSI. After mapping of the first UCI is completed, the terminal device performs resource mapping on the second UCI, without taking into consideration an order among the second HARQ-ACK, CSI-1 of the second CSI, and CSI-2 of the second CSI.

Specifically, the terminal device maps the first HARQ-ACK in the order of firstly frequency domain and then time domain, starting from first symbol which is after an OFDM symbol corresponding to the target REs.

The terminal device maps CSI-1 of the first CSI, starting from an OFDM symbol corresponding to the 1^{st} non-target RE in REs of the second PUCCH. CSI-1 of the first CSI cannot be mapped onto an RE(s) reserved for the first HARQ-ACK, or REs onto which the first HARQ-ACK is mapped. CSI-1 of the first CSI is not frequency-division multiplexed with a coherently demodulated signal.

The terminal device maps CSI-2 of the first CSI, starting from the OFDM symbol corresponding to the 1^{st} non-target RE in the resource for the second PUCCH. CSI-2 of the first CSI can be mapped onto the RE(s) reserved for the first HARQ-ACK, but cannot be mapped onto the REs onto which the first HARQ-ACK is mapped or REs onto which CSI-1 is mapped. CSI-2 of the first CSI is not frequency-division multiplexed with a coherently demodulated signal.

The terminal device maps the second UCI, starting from the OFDM symbol corresponding to the 1^{st} non-target RE in REs for the second PUCCH. The second UCI can be mapped onto the RE(s) reserved for the first HARQ-ACK, but cannot be mapped onto a RE onto which the first UCI is mapped. The second UCI is not frequency-division multiplexed with a coherently demodulated signal.

When mapping the first HARQ-ACK, CSI-1 of the first CSI, and CSI-2 of the first CSI, the terminal device adopts distributed mapping with an interval d. In other words, positions of REs occupied in each OFDM symbol are as follows.

If the number of REs for unmapped first UCI after scheduling is greater than the number of available REs in an OFDM symbol, d=1. That is, if there is still unmapped first UCI, the terminal device will continue to map the first UCI onto a next OFDM symbol.

If the number of REs for the unmapped first UCI after scheduling is less than the number of available REs in an OFDM symbol, d is equal to a ratio of the number of available REs in an OFDM symbol to the number of REs after scheduling.

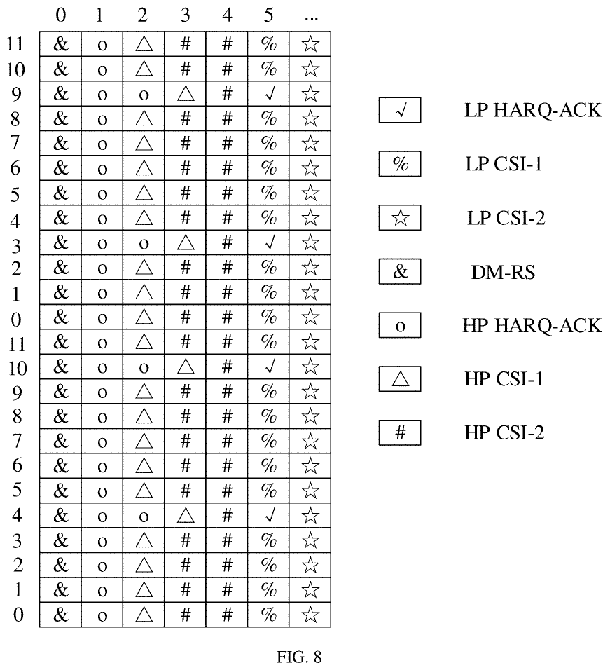

For example, refer to FIG. 8, which is a schematic diagram illustrating resource mapping provided in implementations of the disclosure. As illustrated in FIG. 8, an OFDM symbol with index 0 is used for transmission of a coherently demodulated signal which can also be referred to as a front loaded DMRS, as denoted by square grids with “&” in FIG. 8. The terminal device maps the first HARQ-ACK, starting from an OFDM symbol with index 1. Since the number of REs for the first HARQ-ACK is greater than the number of available REs in the OFDM symbol with index 1, d=1. The terminal device maps unmapped first HARQ-ACK onto an OFDM symbol with index 2. The number of REs for the unmapped first HARQ-ACK is less than the number of available REs in the OFDM symbol with index 2, and thus the terminal device maps the unmapped first HARQ-ACK onto REs corresponding to indexes 4, 10, 3, and 9 in frequency domain in the OFDM symbol with index 2, as denoted by square grid with “o” in FIG. 8. Then the terminal device maps CSI-1 of the first CSI, starting from an RE with index 0 in frequency domain in the OFDM symbol with index 2, and the terminal device cannot map CSI-1 of the first CSI onto the REs corresponding to indexes 4, 10, 3, and 9 in frequency domain onto which the first HARQ-ACK is mapped, as denoted by square grids with “Δ” in FIG. 8. Then the terminal device maps CSI-2 of the first CSI, starting from an RE with index 0 in frequency domain in an OFDM symbol with index 3, and CSI-2 of the first CSI cannot be mapped onto REs with indexes 4, 10, 3, and 9 in frequency domain onto which CSI-1 is mapped, as denoted by square grids with “#” in FIG. 8. Then the terminal device maps the second UCI, starting from an RE with index 0 in frequency domain in an OFDM symbol with index 5, as denoted by square grids with “√”, “⋆”, and “%” in FIG. 8.

Optionally, if there are two high-priority services, the first PUSCH will overlap with the first PUCCH in time domain. In this case, the terminal device can determine that the first PUSCH is to carry control information such as UCIs corresponding to the two high-priority services. For implementations thereof, reference can be made to the foregoing implementations in which there are both a high-priority service and a low-priority service, which will not be elaborated again herein.

In implementations of the disclosure, if the first PUSCH carrying the first UCI overlaps with the second PUCCH carrying the second UCI in time domain, the terminal device transmits the first PUSCH carrying the first UCI and the second UCI to the access-network device, thereby achieving multiplexing of the first UCI and the second UCI and thus avoiding discarding of the second UCI. Therefore, by implementing the implementations of the disclosure, it is possible to improve throughput and performance of a communication system.

The methods of implementations of the disclosure have been elaborated above. For the sake of better implementation of the above schemes of implementations of the disclosure, the following will provide apparatuses of implementations of the disclosure accordingly.

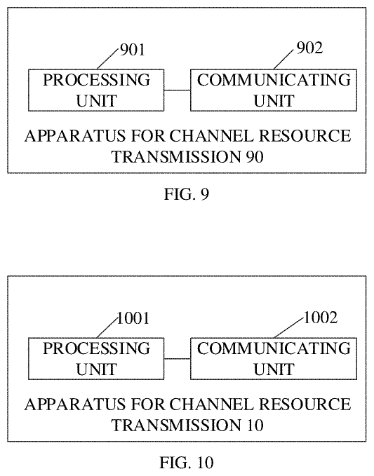

Refer to FIG. 9, which is a schematic structural diagram of an apparatus for channel resource transmission provided in implementations of the disclosure. The apparatus for channel resource transmission can be applied to the terminal device in the foregoing method implementations. The apparatus illustrated in FIG. 9 can be configured to perform some or all functions in the foregoing method implementations illustrated in FIG. 2. Detailed elaborations of various units are as follows.

A processing unit 901 is configured to determine a first information-amount of first UCI and a second information-amount of second UCI. The first UCI is carried on a first PUCCH, the second UCI is carried on a second PUCCH. The first PUCCH overlaps with the second PUCCH in time domain, and the first UCI has a higher priority than the second UCI. The processing unit 901 is configured to determine, according to the first information-amount and the second information-amount, whether the first UCI and the second UCI are to be carried on the first PUCCH. A communicating unit 902 is configured to transmit the first PUCCH to an access-network device if the first UCI and the second UCI are determined to be carried on the first PUCCH, where the first PUCCH carries the first UCI and the second UCI.

In a possible implementation, if the first PUCCH is of format 0 or format 1, and the processing unit 901 is specifically configured to determine that the first UCI and the second UCI are to be carried on the first PUCCH, on condition that a sum of the first information-amount and the second information-amount is less than or equal to a first channel-capacity threshold corresponding to the first PUCCH.

In a possible implementation, if the first PUCCH is of format 2, format 3, or format 4, the processing unit 901 is specifically configured to determine that the first UCI and the second UCI are to be carried on the first PUCCH, on condition that a third information-amount is less than or equal to a second channel-capacity threshold corresponding to the first PUCCH. The third information-amount is determined according to the first information-amount, the second information-amount, a first code rate of the first UCI, and a second code rate of the second UCI.

In a possible implementation, the first UCI is transmitted on the first PUCCH with the first code rate, the second UCI is transmitted on the first PUCCH with the second code rate, and the first code rate and the second code rate are pre-configured for the first PUCCH by the access-network device via higher-layer signaling.

In a possible implementation, if the first PUCCH is of format 2 and target REs for the first PUCCH are used for DMRS transmission, the processing unit 901 is specifically configured to obtain first jointly-encoded information by performing joint encoding on the first UCI, and obtain second jointly-encoded information by performing joint encoding on the second UCI. The processing unit 901 is specifically configured to map the first jointly-encoded information, starting from a first non-target RE in an order of firstly frequency domain and then time domain. The processing unit 901 is specifically configured to map the second jointly-encoded information, starting from a first non-target RE in a remaining resource for the first physical control channel in the order of firstly frequency domain and then time domain.

In a possible implementation, if the first PUCCH is of format 3 or format 4 and target REs for the first PUCCH are used for DMRS transmission, the processing unit 901 is specifically configured to obtain first jointly-encoded information and first separately-encoded information by encoding the first UCI, and obtain second jointly-encoded information and second separately-encoded information by encoding the second UCI. The processing unit 901 is specifically configured to map the first jointly-encoded information evenly onto REs which are at both sides of the target REs in an order of firstly frequency domain and then time domain. The processing unit 901 is specifically configured to map the second jointly-encoded information evenly onto REs which are at both sides of the target REs, other than REs corresponding to the first jointly-encoded information, in the order of firstly frequency domain and then time domain. The processing unit 901 is specifically configured to map the first separately-encoded information onto a first remaining resource in the order of firstly frequency domain and then time domain, where the first remaining resource is REs in a resource for the first PUCCH other than the REs corresponding to the first jointly-encoded information and REs corresponding to the second jointly-encoded information. The processing unit 901 is specifically configured to map the second separately-encoded information onto a second remaining resource in the order of firstly frequency domain and then time domain, where the second remaining resource is REs in the resource for the first PUCCH other than the REs corresponding to the first jointly-encoded information, the REs corresponding to the second jointly-encoded information, and REs corresponding to the first separately-encoded information.

In a possible implementation, if the first PUCCH is of format 3 or format 4 and target REs for the first PUCCH are used for DMRS transmission, the processing unit 901 is specifically configured to obtain first jointly-encoded information and first separately-encoded information by encoding the first UCI, and obtain second jointly-encoded information and second separately-encoded information by encoding the second UCI. The processing unit 901 is specifically configured to map the first jointly-encoded information evenly onto REs which are at both sides of the target REs in an order of firstly frequency domain and then time domain. The processing unit 901 is specifically configured to map the first separately-encoded information onto a first remaining resource in the order of firstly frequency domain and then time domain, where the first remaining resource is REs in a resource for the first PUCCH other than REs corresponding to the first jointly-encoded information. The processing unit 901 is specifically configured to map the second jointly-encoded information onto a second remaining resource in the order of firstly frequency domain and then time domain, where the second remaining resource is REs in the resource for the first PUCCH other than the REs corresponding to the first jointly-encoded information and REs corresponding to the first separately-encoded information. The processing unit 901 is specifically configured to map the second separately-encoded information onto a third remaining resource in the order of firstly frequency domain and then time domain, where the third remaining resource is REs in the resource for the first PUCCH other than the REs corresponding to the first jointly-encoded information, REs corresponding to the second jointly-encoded information, and the REs corresponding to the first separately-encoded information.

Refer to FIG. 9, which is a schematic structural diagram of an apparatus for channel resource transmission provided in implementations of the disclosure. The apparatus for channel resource transmission can be applied to the terminal device in the foregoing method implementations. The apparatus illustrated in FIG. 9 can be configured to perform some or all functions in the foregoing method implementations illustrated in FIG. 6. Detailed elaborations of various units are as follows.

A processing unit 901 is configured to determine the number of first REs for a first UCI and the number of second REs for a second UCI. The first UCI is carried on a first PUSCH, and the second UCI is carried on a second PUCCH. The first PUSCH overlaps with the second PUCCH in time domain, and the first UCI has a higher priority than the second UCI. The processing unit 901 is configured to map the second UCI into REs of the first PUSCH with the number of the second REs. A communicating unit 902 is configured to transmit the target physical uplink channel carrying the first UCI and the second UCI to an access-network device.

In a possible implementation, the processing unit 901 is specifically configured to determine the number of first REs for the first UCI according to a first offset-parameter group for the first UCI, and determine the number of the REs for the second UCI according to a second offset-parameter group for the second UCI. The first offset-parameter group for the first UCI and the second offset-parameter group for the second UCI are configured via higher-layer signaling.

In a possible implementation, the processing unit 901 is specifically configured to receive indication information from the access-network device, where the indication information indicates a first offset-parameter group for the first UCI and a second offset-parameter group for the second UCI, the first offset-parameter group and the second offset-parameter group are selected from offset-parameter groups, and the offset-parameter groups are configured by the access-network device via higher-layer signaling. The processing unit 901 is specifically configured to determine the number of the first REs for the first UCI according to the first offset-parameter group, and determine the number of the second REs for the second UCI according to the second offset-parameter group.

In a possible implementation, if the offset-parameter groups include a first set of offset-parameter groups and a second set of offset-parameter groups, and the first set of offset-parameter groups and the second set of offset-parameter groups each include m offset parameter groups, the indication information indicates that the first offset-parameter group is an i^{th} group among the first set of offset-parameter groups and the second offset-parameter group is an i^{th} group among the second set of offset-parameter groups.

In a possible implementation, if the offset-parameter groups include n sets of offset-parameter groups, and each set of offset-parameter groups includes two offset parameter groups, the indication information indicates that the first offset-parameter group is first group among a j^{th} set of offset-parameter groups and the second offset-parameter group is second group among the j^{th} set of offset-parameter groups, and the j^{th} set of offset-parameter groups is selected from the n sets of offset-parameter groups.

In a possible implementation, target REs of the first PUSCH are used for DMRS transmission, and the processing unit 901 is specifically configured to map the first UCI, starting from the 1^{st} non-target RE in the first PUSCH in an order of firstly frequency domain and then time domain. The processing unit 901 is specifically configured to map the second UCI, starting from the 1^{st} non-target RE in remaining REs of the first PUSCH in the order of firstly frequency domain and then time domain. The processing unit 901 is specifically configured to transmit the first PUSCH carrying the first UCI and the second UCI to the access-network device.

Refer to FIG. 10, which is a schematic structural diagram of an apparatus for channel resource transmission provided in implementations of the disclosure. The apparatus for channel resource transmission can be applied to the access-network device in the foregoing method implementations. The apparatus illustrated in FIG. 10 can be configured to perform some or all functions in the foregoing method implementations illustrated in FIG. 2. Detailed elaborations of various units are as follows.

A processing unit 1001 is configured to determine a first information-amount of first UCI and a second information-amount of second UCI. The first UCI is carried on a first PUCCH, and the second UCI is carried on a second PUCCH. The first PUCCH overlaps with the second PUCCH in time domain, and the first UCI has a higher priority than the second UCI. The processing unit 1001 is configured to determine, according to the first information-amount and the second information-amount, whether the first PUCCH carries the first UCI and the second UCI. A communicating unit 1002 is configured to receive the first PUCCH from a terminal device, if the first PUCCH is determined to be carrying the first UCI and the second UCI, where the first PUCCH carries the first UCI and the second UCI.

In a possible implementation, if the first PUCCH is of format 0 or format 1, the processing unit 1001 is specifically configured to determine that the first PUCCH carries the first UCI and the second UCI, on condition that a sum of the first information-amount and the second information-amount is less than or equal to a first channel-capacity threshold corresponding to the first PUCCH.

In a possible implementation, if the first PUCCH is of format 2, format 3, or format 4, the processing unit 1001 is specifically configured to determine that the first PUCCH carries the first UCI and the second UCI, on condition that a third information-amount is less than or equal to a second channel-capacity threshold corresponding to the first PUCCH. The third information-amount is determined according to the first information-amount, the second information-amount, a first code rate of the first UCI, and a second code rate of the second UCI.

In a possible implementation, the first UCI is transmitted on the first PUCCH with the first code rate, the second UCI is transmitted on the first PUCCH with the second code rate, and the first code rate and the second code rate are pre-configured for the first PUCCH via higher-layer signaling.

Refer to FIG. 10, which is a schematic structural diagram of an apparatus for channel resource transmission provided in implementations of the disclosure. The apparatus for channel resource transmission can be applied to the access-network device in the foregoing method implementations. The apparatus illustrated in FIG. 10 can be configured to perform some or all functions in the foregoing method implementations illustrated in FIG. 6. Detailed elaborations of various units are as follows.

A processing unit 1001 is configured to determine the number of first REs for a first UCI and the number of second REs for a second UCI. The first UCI is carried on a first PUSCH, and the second UCI is carried on a second PUCCH. The first PUSCH overlaps with the second PUCCH in time domain, and the first UCI has a higher priority than the second UCI. A communicating unit 1002 is configured to receive the first PUSCH carrying the first UCI and the second UCI from a terminal device, where the second UCI is mapped into REs of the first PUSCH with the number of the second REs.

In a possible implementation, the processing unit 1001 is specifically configured to determine the number of the REs for the first UCI according to a first offset-parameter group for the first UCI, and determine the number of the REs for the second UCI according to a second offset-parameter group for the second UCI. The first offset-parameter group for the first UCI and the second offset-parameter group for the second UCI are configured via higher-layer signaling.

In a possible implementation, the processing unit 1001 is specifically configured to transmit indication information to the terminal device, where the indication information indicates a first offset-parameter group for the first UCI and a second offset-parameter group for the second UCI, the first offset-parameter group and the second offset-parameter group are selected from offset-parameter groups, and the offset-parameter groups are configured via higher-layer signaling. The processing unit 1001 is specifically configured to determine the number of the first REs for the first UCI according to the first offset-parameter group, and determine the number of the second REs for the second UCI according to the second offset-parameter group.

In a possible implementation, if the offset-parameter groups include a first set of offset-parameter groups and a second set of offset-parameter groups, and the first set of offset-parameter groups and the second set of offset-parameter groups each include m offset parameter groups, the indication information indicates that the first offset-parameter group is an i^{th} group among the first set of offset-parameter groups and the second offset-parameter group is an i^{th} group among the second set of offset-parameter groups.

In a possible implementation, if the offset-parameter groups include n sets of offset-parameter groups, and each set of offset-parameter groups includes two offset parameter groups, the indication information indicates that the first offset-parameter group is first group among a j^{th} set of offset-parameter groups and the second offset-parameter group is second group among the j^{th} set of offset-parameter groups, and the j^{th} set of offset-parameter groups is selected from the n sets of offset-parameter groups.

According to another implementation of the disclosure, various units in the apparatuses for channel resource transmission illustrated in FIG. 9 and FIG. 10 can be respectively or all combined into one or several other units, or some unit(s) can be subdivided into multiple smaller units in terms of functions, which can implement the same operations without affecting realization of the technical effect of the implementations of the disclosure. The above units are divided based on logical functions. In practice, functions of one unit can also be realized by multiple units, or functions of multiple units can be realized by one unit. In other implementations of the disclosure, the apparatuses for channel resource transmission can also include other units. In practice, these functions can also be implemented with aid of other units, and can be implemented by multiple units cooperatively.

Based on the same concept, the apparatuses for channel resource transmission provided in implementations of the disclosure are similar to the methods for channel resource transmission in the method implementations of the disclosure in terms of principles for solving problems and advantages. Reference can be made to the principles and advantages of the methods, which will not be repeated herein for the sake of brevity.

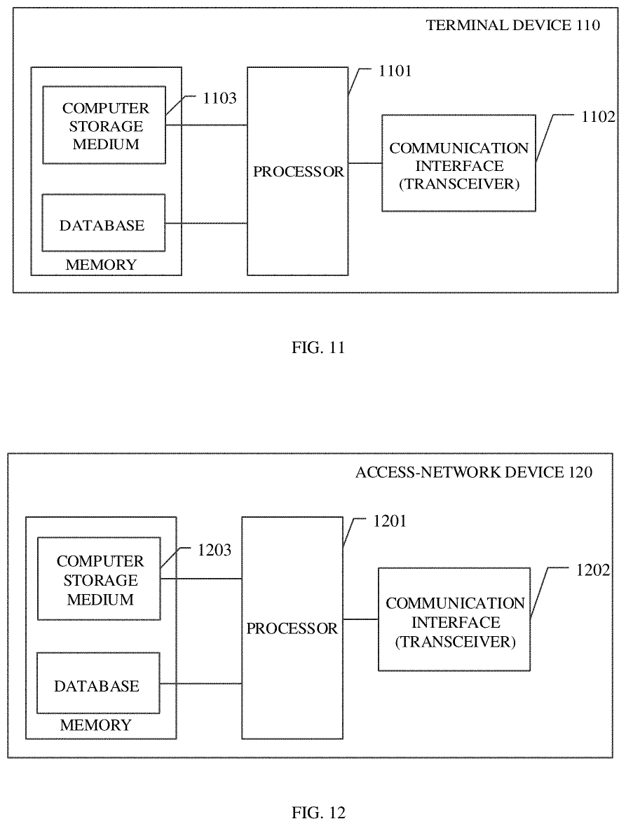

Based on illustrations of the foregoing method implementations and apparatus implementations, implementations of the disclosure further provide a schematic structural diagram of a terminal device. The terminal device can be equipped with the apparatus for channel resource transmission illustrated in FIG. 9 in the foregoing apparatus implementations. Referring to FIG. 11, the terminal device 110 at least includes a processor 1101, a communication interface 1102 such as a transceiver, and a computer storage medium 1103. The processor 1101, the communication interface 1102, and the computer storage medium 1103 of the terminal may be coupled via a bus or in other manners.

The computer storage medium 1103 may be stored in a memory of the terminal device. The computer storage medium 1103 is configured to store computer programs. The computer programs include program instructions. The processor 1101 is configured to execute the program instructions stored in the computer storage medium 1103. The processor 1101 (or referred to as central processing unit (CPU)) is a computing core and control core of a device, which can execute one or more instructions, and specifically load and execute the one or more instructions to implement a procedure of the method for channel resource transmission or corresponding functions.

Implementations of the disclosure further provide a computer-readable storage medium. The computer storage medium is a memory terminal device in the terminal device, and is configured to store programs and data. It can be understood that, the computer-readable storage medium herein may include a built-in storage medium of the terminal device, and may also include an extended storage medium supported by the terminal device. The computer-readable storage medium provides a storage space, where an operating system of the terminal device is stored in the storage space. In addition, one or more instructions which can be loaded and executed by the processor 1101 are also stored in the storage space, and these instructions may be one or more computer programs (including program codes). It should be noted that, the computer-readable storage medium herein can be a high-speed random access memory (RAM), or a non-volatile memory such as at least one magnetic-disc memory. Optionally, the computer-readable storage medium may also be at least one computer storage medium which is located far away from the processor described above.

In an implementation, the processor 1101 can load and execute one or more instructions stored in the computer-readable storage medium, to implement operations performed by the terminal device in the methods for channel resource transmission illustrated in FIG. 2 and FIG. 6.

Based on illustrations of the foregoing method implementations and apparatus implementations, implementations of the disclosure further provide a schematic structural diagram of an access-network device. The access-network device can be equipped with the apparatus for channel resource transmission illustrated in FIG. 10 in the foregoing apparatus implementations. Referring to FIG. 12, the access-network device 120 at least includes a processor 1201, a communication interface 1202 such as a transceiver, and a computer storage medium 1203. The processor 1201, the communication interface 1202, and the computer storage medium 1203 of the terminal may be coupled via a bus or in other manners.

The computer storage medium 1203 may be stored in a memory of the access-network device. The computer storage medium 1203 is configured to store computer programs. The computer programs include program instructions. The processor 1201 is configured to execute the program instructions stored in the computer storage medium 1203. The processor 1201 (or referred to as CPU) is a computing core and control core of a device, which can execute one or more instructions, and specifically load and execute the one or more instructions to implement a procedure of the method for channel resource transmission or corresponding functions.

Implementations of the disclosure further provide a computer-readable storage medium. The computer storage medium is a memory access-network device in the access-network device, and is configured to store programs and data. It can be understood that, the computer-readable storage medium herein may include a built-in storage medium of the access-network device, and may also include an extended storage medium supported by the access-network device. The computer-readable storage medium provides a storage space, where an operating system of the access-network device is stored in the storage space. In addition, one or more instructions which can be loaded and executed by the processor 1201 are also stored in the storage space, and these instructions may be one or more computer programs (including program codes). It should be noted that, the computer-readable storage medium herein can be a high-speed RAM, or a non-volatile memory such as at least one magnetic-disc memory. Optionally, the computer-readable storage medium may also be at least one computer storage medium which is located far away from the processor described above.

In an implementation, the processor 1201 can load and execute one or more instructions stored in the computer-readable storage medium, to implement operations performed by the access-network device in the methods for channel resource transmission illustrated in FIG. 2 and FIG. 6.

Based on the same concept, the terminal device and the access-network device provided in implementations of the disclosure are similar to the methods for channel resource transmission in the method implementations of the disclosure in terms of principles for solving problems and advantages. Reference can be made to the principles and advantages of the methods, which will not be repeated herein for the sake of brevity.

In some implementations, a method for channel resource transmission is provided in the disclosure. The method includes the following. A terminal device determines a first information-amount of first uplink control information (UCI) and a second information-amount of second UCI. The first UCI is carried on a first physical uplink control channel (PUCCH), and the second UCI is carried on a second PUCCH. The first PUCCH overlaps with the second PUCCH in time domain, and the first UCI has a higher priority than the second UCI. The terminal device determines, according to the first information-amount and the second information-amount, whether the first UCI and the second UCI are to be carried on the first PUCCH. The terminal device transmits the first PUCCH to an access-network device if the terminal device determines that the first UCI and the second UCI are to be carried on the first PUCCH, where the first PUCCH carries the first UCI and the second UCI.

In some implementations, a method for channel resource transmission is provided in the disclosure. The method includes the following. An access-network device determines a first information-amount of first UCI and a second information-amount of second UCI. The first UCI is carried on a first PUCCH, and the second UCI is carried on a second PUCCH. The first PUCCH overlaps with the second PUCCH in time domain, and the first UCI has a higher priority than the second UCI. The access-network device determines, according to the first information-amount and the second information-amount, whether the first PUCCH carries the first UCI and the second UCI. The access-network device receives the first PUCCH from a terminal device, if the access-network device determines that the first PUCCH carries the first UCI and the second UCI, where the first PUCCH carries the first UCI and the second UCI.

In some implementations, a method for channel resource transmission is provided in the disclosure. The method includes the following. An access-network device determines the number of REs for first UCI and the number of REs for second UCI. The first UCI is carried on a first PUSCH, and the second UCI is carried on a second PUCCH. The first PUSCH overlaps the second PUCCH in time domain, and the first UCI has a higher priority than the second UCI. The access-network device receives the first PUSCH carrying the first UCI and the second UCI from a terminal device, where the second UCI are mapped into REs of the first PUSCH with the number of the second REs at the terminal device.

In some implementations, an apparatus for channel resource transmission is provided in the disclosure. The apparatus includes a processing unit and a communicating unit. The processing unit is configured to determine a first information-amount of first UCI and a second information-amount of second UCI. The first UCI is carried on a first PUCCH, the second UCI is carried on a second PUCCH. The first PUCCH overlaps with the second PUCCH in time domain, and the first UCI has a higher priority than the second UCI. The processing unit is configured to determine, according to the first information-amount and the second information-amount, whether the first UCI and the second UCI are to be carried on the first PUCCH. The communicating unit is configured to transmit the first PUCCH to an access-network device if the first UCI and the second UCI are determined to be carried on the first PUCCH, where the first PUCCH carries the first UCI and the second UCI.

In some implementations, an apparatus for channel resource transmission is provided in the disclosure. The apparatus includes a processing unit and a communicating unit. The processing unit is configured to determine a first information-amount of first UCI and a second information-amount of second UCI. The first UCI is carried on a first PUCCH, and the second UCI is carried on a second PUCCH. The first PUCCH overlaps with the second PUCCH in time domain, and the first UCI has a higher priority than the second UCI. The processing unit is configured to determine, according to the first information-amount and the second information-amount, whether the first PUCCH carries the first UCI and the second UCI. The communicating unit is configured to receive the first PUCCH from a terminal device, if the first PUCCH is determined to be carrying the first UCI and the second UCI, where the first PUCCH carries the first UCI and the second UCI.

In some implementations, an access-network device is provided in the disclosure. The access-network device includes a memory and a processor coupled with the memory. The memory is configured to store computer-readable instructions. The processor is configured to execute the computer-readable instructions to cause the access-network device to perform the methods described in the second aspect and in the fourth aspect.

In some implementations, a computer-readable storage medium is provided in the disclosure. The computer-readable storage medium is configured to store one or more instructions. The one or more instructions can be loaded by a processor to perform the methods described in the first aspect and in the third aspect.

In some implementations, a computer-readable storage medium is provided in the disclosure. The computer-readable storage medium is configured to store one or more instructions. The one or more instructions can be loaded by a processor to perform the methods described in the second aspect and in the fourth aspect.

In the disclosure, if the first PUCCH carrying the first UCI overlaps with for the second PUCCH carrying the second UCI in time domain, the terminal device firstly determines information amounts of the first UCI and the second UCI, and then according to whether the information amounts exceed a channel capacity of the first PUCCH, the terminal devices determines whether the first UCI and the second UCI are to be carried on the first PUCCH. If the information amounts of the first UCI and the second UCI do not exceed the channel capacity of the first PUCCH, the first UCI and the second UCI can be multiplexed, thereby avoiding discarding of the second UCI. Therefore, by implementing the disclosure, it is possible to improve throughput and performance of a communication system.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for channel resource transmission, comprising:
determining, by a terminal device, a number of first resource elements (REs) for a first uplink control information (UCI) and a number of second REs for a second UCI respectively, the first UCI being carried on a first physical uplink shared channel (PUSCH), the second UCI being carried on a second physical uplink control channel (PUCCH), wherein the first PUSCH overlaps with the second PUCCH in time domain, and the first UCI has a higher priority than the second UCI;
mapping, by the terminal device, the second UCI into REs of the first PUSCH with the number of the second REs; and
transmitting, by the terminal device, the first PUSCH carrying the first UCI and the second UCI to an access-network device.

2. The method of claim 1, wherein determining, by the terminal device, the number of the first REs for the first UCI and the number of the second REs for the second UCI respectively comprises:
determining, by the terminal device, the number of the first REs for the first UCI according to a first offset-parameter group for the first UCI; and
determining, by the terminal device, the number of the second REs for the second UCI according to a second offset-parameter group for the second UCI, wherein
the first offset-parameter group for the first UCI and the second offset-parameter group for the second UCI are configured via higher-layer signaling.

3. The method of claim 1, wherein determining, by the terminal device, the number of the first REs for the first UCI and the number of the second REs for the second UCI respectively comprises:
receiving, by the terminal device, indication information from the access-network device, wherein the indication information indicates a first offset-parameter group for the first UCI and a second offset-parameter group for the second UCI, the first offset-parameter group and the second offset-parameter group are selected from offset-parameter groups, and the offset-parameter groups are configured via higher-layer signaling;
determining, by the terminal device, the number of the first REs for the first UCI according to the first offset-parameter group; and
determining, by the terminal device, the number of the second REs for the second UCI according to the second offset-parameter group.

4. The method of claim 3, wherein the offset-parameter groups comprise a first set of offset-parameter groups and a second set of offset-parameter groups, and the first set of offset-parameter groups and the second set of offset-parameter groups each comprise m offset parameter groups, the indication information indicates that the first offset-parameter group is an i^{th} group among the first set of offset-parameter groups and the second offset-parameter group is an i^{th} group among the second set of offset-parameter groups.

5. The method of claim 3, wherein the offset-parameter groups comprise n sets of offset-parameter groups, and each set of offset-parameter groups comprises two offset parameter groups, the indication information indicates that the first offset-parameter group is first group among a j^{th} set of offset-parameter groups and the second offset-parameter group is second group among the j^{th} set of offset-parameter groups, and the j^{th} set of offset-parameter groups is selected from the n sets of offset-parameter groups.

6. The method of claim 1, wherein target REs of the first PUSCH are used for demodulation reference signal (DMRS) transmission, and mapping, by the terminal device, the second UCI into REs of the first PUSCH with the number of the second REs comprises:
mapping, by the terminal device, the first UCI, starting from first non-target RE in the first PUSCH in an order of firstly frequency domain and then time domain; and
mapping, by the terminal device, the second UCI, starting from first non-target RE in remaining REs of the first PUSCH in the order of firstly frequency domain and then time domain.

7. A terminal device, comprising:
a transceiver;
a processor; and
a memory storing computer-readable programs which, when executed by the processor, are operable with the processor to:
determine a number of first resource elements (REs) for a first uplink control information (UCI) and a number of second REs for a second UCI respectively, the first UCI being carried on a first physical uplink shared channel (PUSCH), the second UCI being carried on a second physical uplink control channel (PUCCH), wherein the first PUSCH overlaps with the second PUCCH in time domain, and the first UCI has a higher priority than the second UCI;
map the second UCI into REs of the first PUSCH with the number of the second REs; and
cause the transceiver to transmit the first PUSCH carrying the first UCI and the second UCI to an access-network device.

8. The terminal device of claim 7, wherein the processor is configured to:
determine the number of the first REs for the first UCI according to a first offset-parameter group for the first UCI; and
determine the number of the second REs for the second UCI according to a second offset-parameter group for the second UCI, wherein
the first offset-parameter group for the first UCI and the second offset-parameter group for the second UCI are configured via higher-layer signaling.

9. The terminal device of claim 7, wherein
the transceiver is configured to receive indication information from the access-network device, wherein the indication information indicates a first offset-parameter group for the first UCI and a second offset-parameter group for the second UCI, the first offset-parameter group and the second offset-parameter group are selected from offset-parameter groups, and the offset-parameter groups are configured via higher-layer signaling;
the processor is configured to determine the number of the first REs for the first UCI according to the first offset-parameter group, and determine the number of the second REs for the second UCI according to the second offset-parameter group.

10. The terminal device of claim 9, wherein the offset-parameter groups comprise a first set of offset-parameter groups and a second set of offset-parameter groups, and the first set of offset-parameter groups and the second set of offset-parameter groups each comprise m offset parameter groups, the indication information indicates that the first offset-parameter group is an i^{th} group among the first set of offset-parameter groups and the second offset-parameter group is an i^{th} group among the second set of offset-parameter groups.

11. The terminal device of claim 9, wherein the offset-parameter groups comprise n sets of offset-parameter groups, and each set of offset-parameter groups comprises two offset parameter groups, the indication information indicates that the first offset-parameter group is first group among a j^{th} set of offset-parameter groups and the second offset-parameter group is second group among the j^{th} set of offset-parameter groups, and the j^{th} set of offset-parameter groups is any one of the n sets of offset-parameter groups.

12. The terminal device of claim 7, wherein target REs of the first PUSCH are used for demodulation reference signal (DMRS) transmission, and the processor is configured to:
map the first UCI, starting from first non-target RE in the first PUSCH in an order of firstly frequency domain and then time domain; and
map the second UCI, starting from first non-target RE in remaining REs of the first PUSCH in the order of firstly frequency domain and then time domain.

13. A non-transitory computer readable storage medium storing computer-readable programs configured to cause a computer to:
determine a number of first resource elements (REs) for a first uplink control information (UCI) and a number of second REs for a second UCI respectively, the first UCI being carried on a first physical uplink shared channel (PUSCH), the second UCI being carried on a second physical uplink control channel (PUCCH), wherein the first PUSCH overlaps with the second PUCCH in time domain, and the first UCI has a higher priority than the second UCI;
map the second UCI into REs of the first PUSCH with the number of the second REs; and
transmit the first PUSCH carrying the first UCI and the second UCI to an access-network device.

14. The non-transitory computer readable storage medium of claim 13, wherein the computer-readable programs are configured to cause the computer to:
determine the number of the first REs for the first UCI according to a first offset-parameter group for the first UCI; and
determine the number of the second REs for the second UCI according to a second offset-parameter group for the second UCI, wherein
the first offset-parameter group for the first UCI and the second offset-parameter group for the second UCI are configured via higher-layer signaling.

15. The non-transitory computer readable storage medium of claim 13, wherein the computer-readable programs are configured to cause the computer to:
receive indication information from the access-network device, wherein the indication information indicates a first offset-parameter group for the first UCI and a second offset-parameter group for the second UCI, the first offset-parameter group and the second offset-parameter group are selected from offset-parameter groups, and the offset-parameter groups are configured via higher-layer signaling;
determine the number of the first REs for the first UCI according to the first offset-parameter group; and
determine the number of the second REs for the second UCI according to the second offset-parameter group.

16. The non-transitory computer readable storage medium of claim 15, wherein the offset-parameter groups comprise a first set of offset-parameter groups and a second set of offset-parameter groups, and the first set of offset-parameter groups and the second set of offset-parameter groups each comprise m offset parameter groups, the indication information indicates that the first offset-parameter group is an i^{th} group among the first set of offset-parameter groups and the second offset-parameter group is an i^{th} group among the second set of offset-parameter groups.

17. The non-transitory computer readable storage medium of claim 15, wherein the offset-parameter groups comprise n sets of offset-parameter groups, and each set of offset-parameter groups comprises two offset parameter groups, the indication information indicates that the first offset-parameter group is first group among a j^{th} set of offset-parameter groups and the second offset-parameter group is second group among the j^{th} set of offset-parameter groups, and the j^{th} set of offset-parameter groups is selected from the n sets of offset-parameter groups.

18. The non-transitory computer readable storage medium of claim 13, wherein target REs of the first PUSCH are used for demodulation reference signal (DMRS) transmission, and the computer-readable programs are configured to cause the computer to:
map the first UCI starting from first non-target RE in the first PUSCH in an order of firstly frequency domain and then time domain; and
map the second UCI starting from first non-target RE in remaining REs of the first PUSCH in the order of firstly frequency domain and then time domain.
